(19) United States
(12) Patent Application Publication
(10) Pub. No.: US 2021/0158633 A1
(43) Pub. Date: May 27, 2021

(54) AUTOMATICALLY TRACKING PERSONAL AND BUSINESS USE OF A VEHICLE

(71) Applicant: 2162256 ALBERTA LTD., Edmonton (CA)

(72) Inventors: Ayman Ammoura, Edmonton (CA); David Mulcair, Edmonton (CA)

(21) Appl. No.: 16/691,595

(22) Filed: Nov. 21, 2019

(51) Int. Cl. G07C 5/02; G08G 1/01; G06F 21/31; G01C 21/34; G06K 9/62

(52) U.S. Cl. CPC G07C 5/02; G08G 1/0133; G06K 9/6267; G01C 21/3438; G06F 21/31

(57) ABSTRACT

Systems and methods for automatically distinguishing and tracking vehicle use for different driving type classifications are disclosed herein. In exemplary embodiments, personal and business use of a vehicle is distinguished and tracked. An orchestration service retrieves driving data from an Original Equipment Manufacturer of a vehicle, which in turn retrieves driving data directly from the vehicle itself. The data is retrieved from the vehicle without the need for installation of specialized hardware within the vehicle. From this driving data, metrics for each vehicle and for each driver can be determined and tracked by driving type classification, and aggregated over time.

### CROSS REFERENCE TO RELATED APPLICATIONS

N/A

### FIELD OF THE INVENTION

The present technology pertains to vehicles, and more particularly, but not by way of limitation, to systems and methods that provide for automatically tracking personal and business use of a vehicle by a user. Some embodiments include utilizing data from the vehicle itself to automatically determine trip metrics for each classification.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes receiving a request from a mobile device to enable a selected vehicle for use by a user associated with the mobile device; verifying that the user is authorized to operate the selected vehicle; transmitting a message to an Original Equipment Manufacturer (OEM) of the selected vehicle to enable the vehicle for use by the user; and receiving a selection from the user of a driving type classification for the intended use of the selected vehicle by the user.

Another general aspect includes a system having a processor; and a memory, the processor being configured to execute instructions stored in memory to receive a request from a mobile device to enable a selected vehicle for use by a user associated with the mobile device; verify that the user is authorized to operate the selected vehicle; transmit a message to an Original Equipment Manufacturer (OEM) of the selected vehicle to enable the vehicle for use by the user; and receive a selection from the user of a driving type classification for the intended use of the selected vehicle by the user.

Other features, examples, and embodiments are described below.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic representation of an example environment where aspects of the present disclosure are practiced.

FIG. 2 illustrates an example graphical user interface on a human machine interface.

FIG. 3 is another schematic representation of an example environment where aspects of the present disclosure are practiced.

FIG. 4 depicts an example graphical user interface for selection of driving type classification.

FIG. 5 is a flowchart of an exemplary method for practicing embodiments of the present invention.

FIG. 6 is a flowchart of an exemplary method for a user device to practice exemplary embodiments of the present invention.

FIG. 7 is a flowchart of an exemplary method for an orchestration service to practice embodiments of the present invention.

FIG. 8 is a diagrammatic representation of an example machine in the form of a computer system.

### DETAILED DESCRIPTION

Generally speaking, the present disclosure is directed to systems and methods that automatically distinguish between and track personal and business use of a vehicle, such as a commercial vehicle, after a driver is authenticated to use the vehicle. That is, the systems and methods herein generally provide for secure access to vehicles by a user. In one example use case, vehicles in a fleet of an enterprise can be accessed and used by an employee or other authorized user using the systems and methods disclosed herein.

In a fleet use scenario, the systems and methods herein can provide for restricted use of vehicles. For example, one or more employees of a company can be provided access to only certain vehicles of that company's fleet as allowed by the class of the driver's license of the employee. Thus, if the employee is not certified to operate a large commercial vehicle, the systems and methods herein prevent the employee from access to such a vehicle.

In embodiments of the present disclosure, after a user has been authorized to operate a particular vehicle of a fleet, the user can choose to input whether the purpose of the upcoming vehicle use will be for business purposes or for personal use. That is, the user can specify whether the user intends to use the vehicle to drive to a location for business or for personal enjoyment. Drive time metrics for the vehicle use trip are sent from the vehicle to an orchestration cloud software system, using a modem pre-installed in the vehicle by its Original Equipment Manufacturer (OEM). This data is transferred from the vehicle to the orchestration system where software runs computations and processing of data. The orchestration system also receives a selection of personal use classification or business use classification. No calculations or decisions are made in the vehicle itself; the vehicle sends the drive time metrics (data) to the orchestration system where the decision making and classification processes are undertaken.

As discussed herein, drive time metrics that are tracked can include any metric such as vehicle speed, total distance driven during the time, acceleration/deceleration patterns, total time vehicle was powered on, etc. If the vehicle trip is for business use, the drive time metrics can be aggregated to determine compliance with one or more government or company-specific regulations. If the vehicle trip is for personal use, the drive time metrics can be aggregated to determine a taxable component of personal use of company vehicle, a depreciation amount for the vehicle, or for any other purpose.

In various embodiments, a user may change a classification during a trip from “personal” to “business” and vice versa. For example, a user may drive to multiple destinations in a given trip and update the classification as necessary between a personal trip nature and a business trip nature.

In various embodiments, drive time metrics may be analyzed to automatically predict whether a particular trip is a business use of the vehicle or a personal use of the vehicle. For example, analysis of time, time of day, day of week, trip location(s) and/or location coordinates may indicate that a trip is for personal use since the vehicle is being driven in a location not usually traveled, in a location within a certain distance of a residence (such as the user's residence or residence of person known to the user), or for a length of time that is longer than normal.

In some embodiments, a user may be required to enter whether a trip is to be for personal use or business use before the vehicle will be allowed to start and drive. In other embodiments, the vehicle may automatically predict whether a trip that was just completed is for business use or personal use, and ask the user or another authorized person to confirm the prediction. In a further embodiment, the vehicle may automatically predict that a trip that began as one classification has likely switched to a different classification, and ask the user to confirm the switch.

In exemplary embodiments, the processes implemented herein allow users to borrow or rent vehicles in an automated manner and using specifically configured vehicles. Some specifically configured vehicles include human machine interfaces and physical interfaces or connectors that couple with a mobile device of a user. In exemplary embodiments, the vehicles are specially configured using specialized software installed by the OEM of the vehicle, and without the need for any specialized hardware installed within the vehicle.

Also, while the present disclosure generally discusses vehicles such as cars, the term “vehicle” is not intended to be limiting. Thus, other types of vehicles or machinery such as boats, planes, drones, or industrial machinery such as a skid or forklift can have controlled access through use of the present disclosure. Further, vehicle can be a consumer use vehicle or a commercial vehicle such as a semi-truck.

Some embodiments include the use of an orchestration system to provide various types of authentication for users. In various embodiments, the orchestration system can cause the vehicle to lock and unlock doors. The orchestration system can also cause the vehicle to perform other actions such as horn honking, light flashing, trunk opening, engine ignition start, and the like.

In some embodiments, these methods and systems allow for the vehicle to be accessed and driven by a user without a key present within the vehicle. These and other advantages of the present disclosure are provided in greater detail herein with reference to the collective drawings.

Authentication of Users

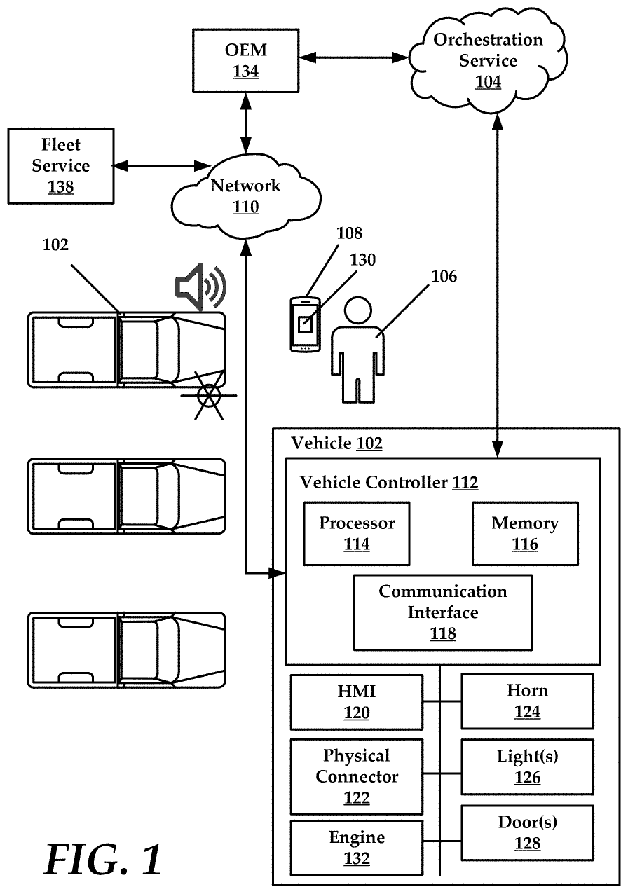

FIG. 1 is a schematic representation of an example environment where aspects of the present disclosure are practiced. In one embodiment, the environment includes a vehicle 102, an orchestration service 104, a user 106, a mobile device 108, and networks 110. For context, the user 106 desires to use the vehicle 102, which can be located amongst a plurality of other vehicles.

In general, each of the components of the environment can communicate over one or more communication network 110. The network 110 may include any one or a combination of multiple different types of networks, such as cable networks, the Internet, cellular networks, wireless networks, and other private and/or public networks. In some instances, the network 110 may include cellular, radio, Wi-Fi, or Wi-Fi direct. In other embodiments, components of the environment can communicate using short-range wireless protocols such as Bluetooth, near-field, infrared, RFID, and the like.

User 106 may request access to a vehicle via mobile device 108. In exemplary embodiments, mobile device 108 may be any movable processor-enabled computing device, such as a smartphone, smartwatch, tablet, netbook, or laptop computer.

Generally, the present disclosure provides an automated and secure vehicle access method that utilizes at least two-factor authentication to authenticate a user to utilize vehicle 102. Some embodiments contemplate more than two factors of authentication. In some embodiments, the vehicle 102 comprises a vehicle controller 112 that in turn comprises a processor 114, memory 116, and a communication interface 118. The vehicle 102 also can include a human machine interface (HMI 120), a physical connector 122, a horn 124, light(s) 126, door(s) 128, and an engine 132.

In various embodiments, the orchestration service 104, vehicle controller 112, and mobile device 108 cooperate to provide automated vehicle access and operation to user 106. In some embodiments, the mobile device 108 implements an application 130 that allows the user 106 to interact with the orchestration service 104. In one or more embodiments, the orchestration service 104 can be implemented as a cloud-based software service, or alternatively in a physical or virtual server configuration.

In various embodiments, the orchestration service 104 is used to perform an automated process to authenticate user 106 to use a particular vehicle 102. According to some embodiments, when the user 106 enters an area near the vehicle 102, the user 106 utilizes the application 130 on the mobile device 108 to obtain a list of available vehicles from the orchestration service 104. Using a location of the mobile device 108 (generated natively within the mobile device), the orchestration service 104 generates the list of available vehicles near the user 106 and transmits the same for display through the application 130 on the mobile device 108. The user 106 can select the vehicle 102 from the list.

In exemplary embodiments, user 106 may be authorized to use only select vehicles in a fleet of vehicles, as determined by an administrator of the fleet. User 106 may only be presented with a list of available vehicles in the authorized fleet on application 130.

In another embodiment, rather than selecting from a list, the user 106 can enter a portion or all of a vehicle identification number (VIN) of their selected vehicle into the application 130 on the mobile device 108. The orchestration service 104 can determine if the vehicle is available for use and if user 106 is authorized to use that vehicle 102 or type of vehicle. In another example embodiment, the user 106 can obtain a picture of the VIN using a camera of the mobile device 108. The orchestration service 104 is configured to determine the VIN number from the photograph received from the mobile device 108.

In another embodiment, the user 106 can be assigned the vehicle 102 rather than the user being allowed to choose. In these instances, the orchestration system 104 can assist the user 106 in locating the vehicle 102 by causing the vehicle controller 112 to activate any of the horn 124 and/or the light(s) 126. This functionality is advantageous when a plurality of vehicles are present. In another example embodiment, the orchestration service 104 can provide the user 106 with a portion or all of the VIN number of the vehicle 102 through the application 130. The user 106 can use the VIN data to differentiate between vehicles and select the proper vehicle. In addition to (or in lieu of) a VIN number, a license plate number, or other identifier for vehicle 102 can be utilized.

It will be understood that prior to using any vehicle, the user 106 creates an account with the orchestration service 104. In some embodiments, registration can be accomplished through the application 130 on the mobile device 108. Once the user is registered and an account established, the user 106 can use a vehicle. The orchestration service 104 can generate a unique identifier for the user 106 during the account creation process.

User 106 may be an employee, or otherwise affiliated with, a company that owns or utilizes a fleet of vehicles. Alternatively, user 106 may be a consumer who simply desires to borrow a vehicle from a fleet, without a preexisting relationship to a company that owns or utilizes the fleet of vehicles.

When the vehicle 102 is selected using any of the methods described, the orchestration service 104 can perform a first type of authentication of the user 106. In this embodiment, the first type of authentication includes the orchestration service 104 verifying that the user 106 is registered (e.g., account properly created) with the orchestration service 104.

In some embodiments, the first type of authentication includes verifying the unique identifier for the user 106 that is stored in the application 130 or otherwise on the mobile device 108. The mobile device 108 transmits this unique identifier (along with the VIN information when needed) to the orchestration service 104.

If the user 106 is registered (through verification of the unique identifier), the orchestration service 104 transmits an unlock command to the vehicle controller 112. The vehicle controller 112 unlocks the door(s) 128 of the vehicle 102 in response to receiving the unlock command.

In addition to transmitting the unlock command, the orchestration service 104 also transmits a code to the application 130 of the mobile device 108. The code is used in a second type of authentication in some embodiments.

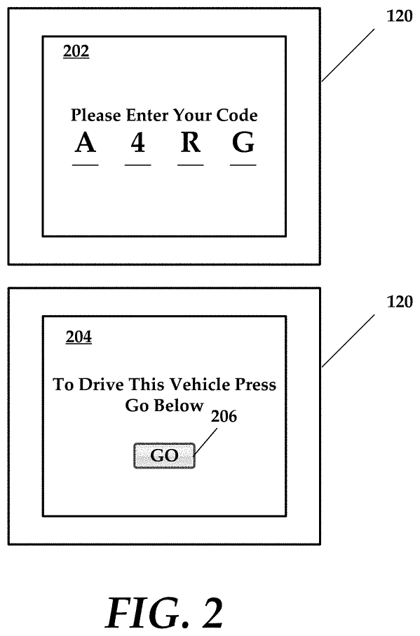

The user 106 can enter this code into a graphical user interface (GUI) presented on the HMI 120 of the vehicle. FIG. 2 illustrates an example code entered into a GUI 202 of the HMI 120. If the code entered into the HMI 120 matches the code generated by the orchestration service 104, the user 106 is presented with another GUI 204 where the user 106 can select a button 206 to confirm that they desire to drive the vehicle 102. To be sure, this is merely an example of how a user could indicate that they wish to use the vehicle, and is not intended to be limiting.

In one or more embodiments, when the code entered into the HMI 120 matches the code generated by the orchestration service 104 and presented to the application 130, the orchestration service 104 can transmit a vehicle start command to the vehicle controller 112. The vehicle controller 112 can start the engine 132 of the vehicle 102 in response, or unlock the engine 132 such that the user can start it using a key. The user 106 can then drive the vehicle 102 away.

In some embodiments, another factor of authentication could include the user 106 plugging their mobile device 108 into the physical connector 122 of the vehicle 102. In some instances, the plugging of the mobile device 108 into the physical connector 122 of the vehicle 102 can replace the code matching process and thus serve as the second factor of authentication. In such an embodiment the vehicle controller 112 and/or the orchestration service 104 can verify aspects of the mobile device 108 or application 130, as will be discussed in greater detail infra.

In one embodiment, the physical connector 122 includes a wired connection that couples the mobile device 108 with, for example, an onboard diagnostics (OBD) port. In another embodiment, the physical connector 122 includes a wired connection that couples the mobile device 108 with, for example, the HMI 120. In yet another embodiment, the physical connector 122 includes a wired connection that couples the mobile device 108 with, for example, the vehicle controller through a universal serial bus (USB) connector or auxiliary port in a dashboard or console of the vehicle 102.

In some embodiments, when the mobile device 108 is connected through the physical connector 122, the vehicle controller 112 can obtain the code and transmit the code to the orchestration service 104 as the second type of authentication rather than requiring the user 106 to type the code into the HMI 120.

According to some embodiments, the vehicle controller 112 can be configured to sense a paired presence of the mobile device 108 during vehicle operations. This can include sensing a connection over the physical connector 122 or a connection over a short-range wireless connection. If the mobile device 108 that initiated the initial authentication is not present, the HMI 120 can present a WARNING that the authentication device (e.g., mobile device 108) is not detected and/or provide direction to the user to return the vehicle 102. This will ensure that only authorized drivers are allowed to operate the vehicle. In another advantage, this prevents the driver or user from driving away and inadvertently forgetting their mobile device 108.

As briefly mentioned above, rather than using a code, the second type of authentication includes the mobile device 108 being connected through the physical connector 122. The vehicle controller 112 reads the unique code referenced above that was used to perform the first type of authentication and provides this unique code that was read directly off of the mobile device 108 by the vehicle controller 112. When this unique code matches the unique code generated by the orchestration service 104 the user 106 is authenticated a second time. Rather than using the unique code a second time, the user 106 can be authenticated a second time by other data such as an International Mobile Equipment Identity (IMEI) of the mobile device 108 or a code that is embedded into the application 130 of the mobile device 108. Another type of immutable value related to the mobile device 108 can also be used. This information can be gathered and stored in the orchestration service 104 when the user 106 creates an account.

In an example general use case, the orchestration service 104 is a system that is configured to perform a first type of authentication of a user using a unique identifier for a user of a mobile device. Next, the orchestration service 104 transmits an unlock request to a vehicle controller 112 when the first type of authentication is complete. The vehicle controller 112 unlocks a door of the vehicle 102 in response. Next, the orchestration service 104 performs a second type of authentication of the user and then transmits an indication to the vehicle controller 112 of the vehicle to confirm that the second type of authentication is complete. Thus, the user can use the vehicle when both the first type of authentication and the second type of authentication are complete by the orchestration service 104.

In another example general use case, the vehicle controller 112 is a system that is configured to receive an indication of a first type of authentication being completed by the orchestration system 104. Next, the vehicle controller 112 receives an unlock command when the first type of authentication is complete. Next, the vehicle controller 112 is configured to receive an indication of a second type of authentication being completed by the orchestration system 104. This may also include receiving an engine start command from the orchestration system 104. In one example, the message that indicates that the first type of authentication is complete is coupled with an unlock command and the message that indicates that the second type of authentication is complete is coupled with an engine start command.

During the term of use, the user 106 can utilize the application 130 to lock and/or unlock the vehicle 102, start the engine 132 of the vehicle 102, and so forth. These functionalities remain active as long as user 106 is authorized by the fleet operator, or the user 106 indicates that they wish to terminate the use.

In some embodiments it will be understood that the user 106 does not need to be in possession of a key for the vehicle 102 in order to use and drive the same. After the user 106 has been authenticated to use vehicle 102, in some embodiments, each time the vehicle 102 experiences a turn off event, the vehicle controller 112 can present the user 106 with a message through the HMI 120 (or through the application 130) that queries the user 106 as to whether the user 106 desires to continue or terminate the vehicle use.

In some embodiments, the user 106 may be required, as directed by applicable laws, to select or agree to various provisions such as insurance, damage waivers, fueling agreements, and so forth. One of ordinary skill in the art will appreciate that these requirements may vary per locale such as by government jurisdiction or company.

According to some embodiments, rather than requiring the orchestration service 104 to perform each factor of authentication, the vehicle controller 112 can be configured to perform one or more of the types of authentication. In one embodiment, the orchestration service 104 performs the first type of authentication, which can include any of the methods described above in order for the door(s) 128 of the vehicle 102 to be unlocked. The second factor of authentication can be completed by the vehicle controller 112. For example, the vehicle controller 112 can generate a random code that is transmitted to the mobile device 108 over a short-range wireless connection via the communication interface 118. The user 106 can enter this code into the HMI 120 of the vehicle 102.

In another embodiment, when the application 130 is active on the mobile device 108, the mobile device 108 can communicate with the vehicle controller 112 when the mobile device 108 is proximate (e.g., within short-range wireless connectivity range). The vehicle controller 112 can be configured to acknowledge a code received over a short-range wireless connection in order to unlock the door(s) 128 of the vehicle 102, as a first type of authentication. The orchestration service 104 can perform a second type of authentication using any of the methods described herein.

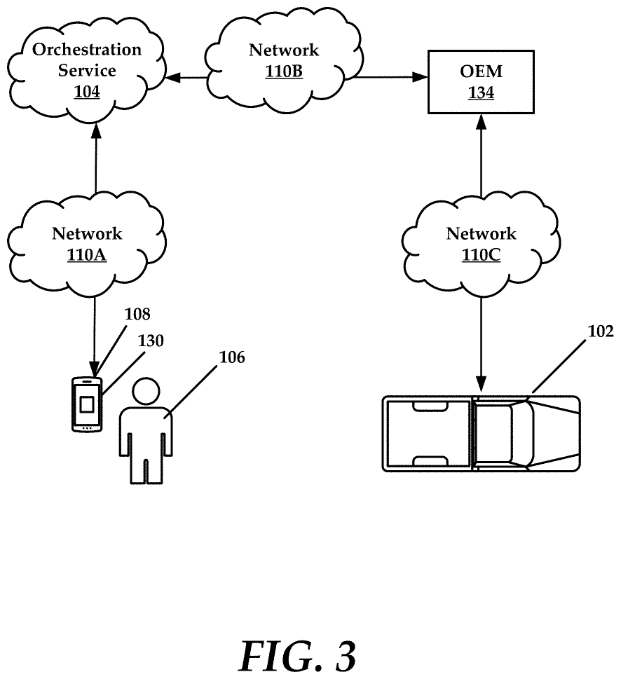

According to some embodiments, the environment of FIG. 1 can also generally include an original equipment manufacturer (OEM) connectivity service or system (OEM 134). An exemplary OEM 134 connectivity system is depicted in FIG. 3.

Controlled Access to Vehicles

Referring back to FIG. 1, the vehicle 102 can include a commercial vehicle, such as a semi-truck. The user can access the vehicle 102 using their mobile device 108 using the methods described above, which can include mediation through the orchestration service 104 and/or the OEM 134. In addition to authenticating the user through their mobile device 108, the orchestration service 104 can also determine that the vehicle type requested is commercial. The orchestration service 104 can maintain a list of vehicles, which are tagged as commercial vehicles or non-commercial vehicles. For example, the orchestration service 104 can maintain a list of vehicles, identified by their VIN number or license plate, which can be tagged as either commercial or non-commercial (e.g., vehicle class). Rather than using a list, the orchestration service 104 can receive vehicle parameters from the vehicle controller 112, which can be searched against the OEM 134 to determine the vehicle type.

Regardless of the method used to determine the vehicle type, once the orchestration service 104 determines that the user is requesting a commercial vehicle, the orchestration service 104 can optionally determine if the user is permitted to utilize the commercial vehicle.

In one embodiment, the orchestration service 104 can maintain a driver profile, which indicates what types of vehicles that a driver/user is authorized to drive. This could include the driver providing credentials to the orchestration service 104, such as driver's license number, or other similar credentials.

Once the vehicle has been identified and the user authenticated, the vehicle 102 can be unlocked and started (e.g., key on event) using the methods disclosed herein. Once the vehicle 102 has been started, the orchestration service 104 can initiate a drive time tracking process. In some embodiments, drive time can be initiated at the key on event when the engine is started, or based on tracked movement of the vehicle 102. For example, when the engine of the vehicle 102 is started, the orchestration service 104 can initiate a clock or counter to track drive time. In some embodiments, the orchestration service 104 can track drive time parameters such as the aforementioned drive time, driving distance, as well as other more granular parameters such as changes in speed over time, which can indicate whether the vehicle is in traffic or is stopped.

The end of the drive time can occur based on a key off event, such as when the vehicle is stopped and the engine is turned off. In various embodiments, the orchestration service 104 can utilize GPS data to determine when the vehicle has stopped, in combination with a signal from the vehicle controller 112 that indicates that an engine off event has occurred. These data indicate that a key off event has occurred, with verification that the vehicle is no longer in motion.

During drive time, the vehicle controller 112 and/or the orchestration service 104 can create a drive log that includes one or more of the drive time parameters collected during drive time. Stated otherwise, the vehicle controller 112 and/or the orchestration service 104 can automatically track driving parameters during a drive time of the vehicle by the user that is initiated by the start of the vehicle. It will be understood that the process or method steps disclosed can occur either at the vehicle level, the orchestration service level, or both. For example, the drive time parameter tracking can occur at the vehicle controller 112 level, with the logged drive time data being transmitted to the orchestration service 104 for collection and analysis.

The orchestration service 104 can maintain a driver log analysis process, for each classification of driving type (such as for personal use and for business use). To be sure, each jurisdiction in which the driver is operating the vehicle 102 may have a unique set of laws pertaining to commercial vehicle driving limits. That is, the driving of commercial vehicles may be governed by laws that control how long a driver can operate a vehicle before being mandated to stop and rest. Each jurisdiction may be subject to unique drive time limitations.

In some instances, a fleet operator or service may maintain a unique set of company specific drive time limitations that may be more stringent than those of a particular jurisdiction. For example, the fleet operator may set forth that the drive time limitations only allow a driver to drive for a certain number of hours or for a certain distance for business use before stopping for at least a preset amount of time, or a driver may only be allowed to use a vehicle for a certain number of hours or for a certain distance for personal use in a predetermined time window.

The orchestration service 104 can be configured to compare current drive time metrics to drive time limitations to determine when the drive time of the user exceeds a predetermined time limit. The predetermined time limit can be based on a relevant statute where the driver and vehicle are currently positioned, in the operating state of origin of the driver, or based on fleet-specific or company-specific regulations. The ability of the orchestration service 104 to track a location of the vehicle 102 in real-time or near-real-time allows for the orchestration service 104 to determine the applicable law or drive time limitations that can be applied. Again, these methods can be performed at the vehicle controller level or the orchestration service level.

When it is determined that the drive time parameters, such as drive time, exceed the predetermined time limit, a warning message can be transmitted to the mobile device 108 or a human machine interface in the vehicle 102. The warning message can indicate that the drive time has exceeded or will soon exceed the predetermined time limit. The vehicle controller 112 or orchestration service 104 can identify a potential stop where the vehicle 102 can be parked, based on a current location for the vehicle 102.

In addition to transmitting a message to the driver through their mobile device 108 or the HMI 120, the message can be transmitted to a supervisor service, such as a fleet service 138 that manages the driver and commercial vehicle.

Also, as the location of the vehicle 102 can be tracked in real-time, it is possible for the vehicle controller 112 and/or the orchestration service 104 to identify when or if the drive time limitations have changed based on a change in vehicle location. As noted above, one jurisdiction may have a first set of drive time limitations and another jurisdiction may have a second set of drive time limitations.

In addition to determining when a driver has exceeded a drive time limitation, the vehicle controller 112 or orchestration service 104 can automatically create a driving log in real-time or near-real-time. In one embodiment, the driving log begins to be populated when the engine is started (key on event). In another embodiment, the driving log begins to be populated when the vehicle begins moving.

The driving log can be populated with any drive time data that is collected by the vehicle controller 112 or orchestration service 104, such as current drive time, drive distance, speed, vehicle weight, and so forth. The drive time data can include time periods when the vehicle is in motion, as well as time frames where the vehicle is not in motion. These data can be specifically formatted into a driving log in some embodiments. That is, the raw data of the driving log can be specifically formatted in some embodiments. In one or more embodiments, the vehicle controller 112 or orchestration service 104 can select and apply a jurisdiction-specific (or generic) driving log template. The driving log template specifies driving data and layout, which can be based on a specific jurisdiction in which the vehicle is currently operating. For example, when the vehicle 102 enters a waypoint, such as a weigh station, the orchestration service 104 could select a driving log template from a plurality of driving log templates based on a current location of the vehicle.

According to some embodiments, when it has been determined by the orchestration service 104 that the driver has exceeded an applicable driving predetermined time limit for a particular type of driving (i.e., business or personal), and the driver has turned off the vehicle, the vehicle controller 112 can prevent the engine of the vehicle from being turned back on until expiration of a break period. That is, the vehicle controller 112 can prevent the engine of the vehicle from being turned back until a specified time, such as six or eight hours after the key-off event. In some embodiments, this process can be controlled using the orchestration service 104, which transmits signals to the vehicle controller 112 to disable vehicle engine starting during the break period. That is, the orchestration service 104 or vehicle controller 112 can cause the vehicle 102 to be disabled after a key off event when the drive time has exceeded the predetermined time limit.

In some embodiments, an override code can be input by the driver through their mobile device 108 or the HMI 120 to allow the vehicle to be operated during the break period. This would allow the vehicle 102 to be moved if a situation warrants, such as an emergency event. In some embodiments, the driver can request that the vehicle 102 be permitted to move by contacting the fleet service 138, which communicates with the orchestration service 104. The orchestration service 104 can transmit to and receive signals from the vehicle controller 112 through the OEM connectivity service 134 in order to allow for these break period activation processes.

OEM Connectivity

In general, some vehicle manufacturers provide a connectivity service that can be used to control certain aspects of vehicle operation. For example, these systems can provide door locking/unlocking, engine start/stop, and other services. In some embodiments, rather that utilizing the orchestration service 104 to issue commands to the vehicle controller 112, the orchestration service 104 can interface with the OEM 134. For example, the orchestration service 104 can be used to perform TFA methods and potentially driver restriction while the OEM 134 is used to issue commands to the vehicle controller 112. Thus, rather than directly issuing commands to the vehicle controller 112, the orchestration service 104 indirectly issues commands to the vehicle controller 112 using the OEM 134. For example, the orchestration service 104 can indicate to the OEM 134 that an unlock command is to be transmitted to the vehicle controller 112. The OEM 134 sends the unlock command in response. In sum, the orchestration service 104 can use the OEM 134 as a proxy to interact with the vehicle controller 112.

In the exemplary environment depicted in FIG. 3, an OEM 134 is in communication with vehicle 102 over network 110C. In various embodiments, only OEM 134 is authorized to install hardware or software onto vehicle 102, and only OEM 134 can communicate directly with vehicle 102 to control aspects of vehicle 102 (such as locking/unlocking of doors, engine start, lights, honking, etc.). Further, only OEM 134 can receive data directly from vehicle, such as vehicle metrics (e.g., distance driven, time driven, acceleration/deceleration patterns, fuel usage, etc.). While not depicted in FIG. 3, vehicle 102 may be part of a bigger fleet of vehicles. OEM 134 may be a manufacturer of vehicle 102 or of one or more components within vehicle 102.

Orchestration service 104 communicates with OEM 134 via network 110B, which may be the same or different network as network 110C. In exemplary embodiments, orchestration service 104 is not capable of communicating directly with vehicle 102. As such, orchestration service 104 cannot directly control any aspects of vehicle 102 and is not authorized to install or operate any hardware or software on vehicle 102.

When user 106 desires to use vehicle 102, user 106 utilizes application 130 operating on user mobile device 108 to access orchestration service 104 and request access to vehicle 102, as discussed herein. Application 130 can communicate with orchestration service 104 via network 110A, which may be the same or different from network 110E and/or network 110C. Exemplary networks 110A-110C may include any one or a combination of multiple different types of networks, such as cable networks, the Internet, cellular networks, wireless networks, and other private and/or public networks. In some instances, the networks may include cellular, Wi-Fi, or Wi-Fi direct. In other embodiments, components of the environment can communicate using short-range wireless protocols such as Bluetooth, near-field, infrared, and the like.

Selection of Personal or Business Use

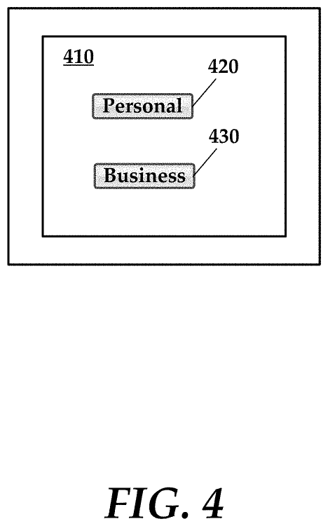

After a user is authenticated by orchestration service 104 to use vehicle 102 using any of the authentication methods disclosed herein, the user may be provided with a graphical user interface where the user selects whether the vehicle use will be for personal use or business use. FIG. 4 depicts an exemplary graphical user interface 410 for selection of a driving type classification by a user. The example graphical user interface 410 has two button options for a user to select: “Personal” 430 or “Business” 430. In exemplary embodiments, user interface 410 may be presented to user 106 on application 130 of mobile device 108, or on HMI 120 of vehicle 102.

In some embodiments, vehicle 102 may be locked from operating until a user makes a selection on graphical user interface 410. In other embodiments, the vehicle may be operable and a default setting is selected if a user declines to make a selection within a predetermined time window of opening a door of vehicle, starting an ignition, beginning vehicle use, or any other predetermined trigger.

As would be understood by persons of ordinary skill in the art, while the words “Personal” and “Business” are depicted on exemplary graphical user interface 410, buttons 420 and/or 430 may instead depict different words, letters, or symbols instead of or in addition to those depicted in FIG. 4. For example, button 420 may simply have a letter “P” or an icon for selection. Button 430 may simply have a letter “B” or an icon for selection. Also, while only two buttons are shown on exemplary user interface 410, there may be additional buttons also present on the interface in various embodiments. For example, additional classifications, a button to return to a previous screen, use a default setting, use a prior trip setting, or any other desired functionality.

Method to Automatically Distinguish and Track

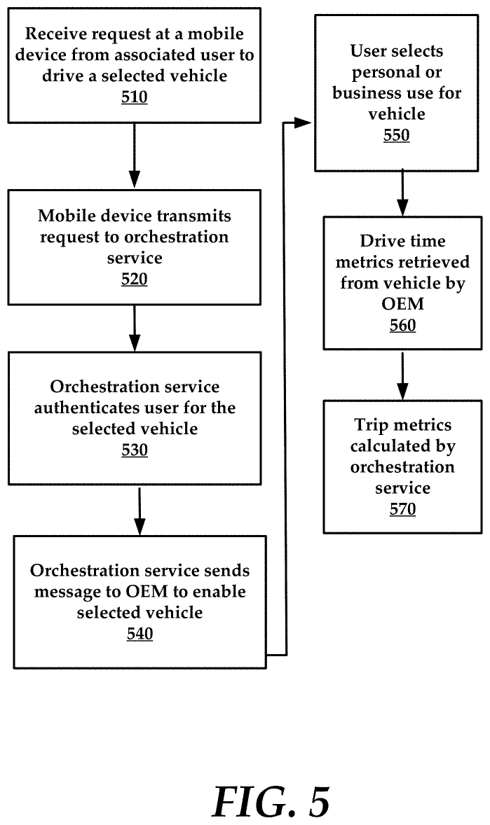

FIG. 5 depicts an exemplary method for practicing embodiments of the present invention. The method steps are described in concert with the environment of FIG. 3 for clarity. As would be understood by persons of ordinary skill in the art, there may be additional or fewer steps than those depicted in exemplary FIG. 5. In addition, some steps of FIG. 5 may be performed in varying order.

In step 510, a mobile device 108 receives a request from a user 106 (via application 130) to use a particular vehicle 102 of a fleet of vehicles. Typically the vehicle 102 is in a disabled state for security purposes. Mobile device 108 submits that request to orchestration service 104 in step 520. Orchestration service 104 then verifies whether the user 106 associated with the mobile device 108 is authorized to drive the selected vehicle 102 of the fleet, in step 530. Optionally, any of the two-factor authentication methods discussed herein may be utilized for this step.

Orchestration service 104 sends either an approval, denial, or request for more information back to mobile device 108. Once authenticated by orchestration service 104, a message is sent by orchestration service 104 to OEM 134 in step 540 that a user has been approved to drive vehicle 102. In exemplary embodiments, orchestration service 104 communicates with OEM 134 via an API (Application Program Interface) that is managed by the OEM itself. OEM 134 then enables vehicle 102 for driving by unlocking a door of the vehicle, enabling an ignition start, disabling a security system on the vehicle, or any other mechanism.

The user 106 will then be asked to select whether the vehicle use will be for personal or business use on either application 130 operating on mobile device 108 or on HMI of the vehicle 102, in step 550. Then the user can drive the vehicle wherever is needed.

Drive time metrics are automatically retrieved from vehicle 102 by OEM 134 over network 110C in step 560 (such as from vehicle controller 112). The metrics may be transmitted to OEM 134 once a trip has been completed (e.g., an engine has been turned off), at certain predetermined time or distance intervals, upon request by a user or administrator, or on any other schedule. In exemplary embodiments, drive time metrics may comprise any one or more metrics from a vehicle dashboard and/or vehicle controller 112. For example, drive time metrics may comprise any one or more of vehicle enabled time, ignition start time, ignition stop time, acceleration patterns, deceleration patterns, fuel usage, tire RPMs, etc.

These metrics may be transmitted by OEM 134 to orchestration service 104, and then processed for further analysis by orchestration service 104 in step 570. For example, orchestration service 104 may use the drive time metrics to automatically complete a commercial driver logbook in accordance with government and/or proprietary regulations. Orchestration service 104 may also determine a personal value received by user 106 for driving a commercial vehicle for personal use. This information can be tracked by an administrator of the fleet of vehicles and also be used for tax reporting purposes. Orchestration service 104 may also determine a depreciation value of vehicle 102 based on a cost of vehicle 102, and generate a report for depreciation for a day, week, month, quarter, year, or any other preset time period. In exemplary embodiments, a depreciation value is determined by orchestration service 104 based on a configurable (and variable) amount of money per distance driven. Orchestration service 104 may then generate the calculated trip metrics and provide them to one or more user(s), and/or administrators of a fleet.

Orchestration service 104 can also aggregate and distinguish personal driving from business driving for a user 106 across any one or more vehicles in a fleet. Personal driving and business driving can also be aggregated and distinguished by vehicle or type of vehicle, regardless of which user is driving the vehicle(s). The data can be processed and aggregated by time, date, daily log, weekly log, monthly log, fuel usage, distance driven, or any other desired parameter.

Streamlined Repeat Use of Vehicle

In various embodiments, a vehicle can be remotely disabled if its engine has been turned off for a predetermined amount of time (e.g., 5-30 minutes). Orchestration service 104 may transmit a message to OEM 134 to disable the vehicle 102 upon receiving data from vehicle controller 112 or directly from vehicle 102 to indicate the engine off time.

To re-enable the vehicle for driving, orchestration service 104 may require that mobile device 108 again identify the vehicle using any of the methods disclosed herein (such as identifying the last 4 digits of a vehicle VIN number). Orchestration service 104 API may request an identifier of the mobile device 108 from application 130 operating on mobile device 108. The identifier of mobile device 108 is cross-referenced with a list of authorized user devices for vehicle 102. In various embodiments, a system administrator adds users and their corresponding identifying information to a database to authorize access to specific vehicles or class(es) of vehicles in one or more fleets. A user may be identified by mobile device attributes such as one or more of a serial number, processor ID, IMEI number, SIM card number, device type (e.g., smartphone, smartwatch, etc.), device phone number, email address, or any other attribute of user 106 and/or mobile device 108.

Once authenticated, user 106 will have access to either the specific vehicle 102, or a class of vehicles similar to vehicle 102. The type of access granted to user 106 is configurable based on business rules, as would be understood by persons of ordinary skill in the art.

Once user 106 is authorized to operate vehicle 102, orchestration service 104 transmits a message to OEM 134 to enable the vehicle. Then user 106 may select whether the vehicle use will be for personal or business use on application 130 of mobile device 108 and drive away.

In an alternate embodiment, user 106 may initialize application 130 and the application will automatically load with information regarding the previous vehicle used by the user 106. The user may simply have to select whether to continue to use the same vehicle on the screen. Then orchestration service 104 transmits a message to OEM 134 to unlock the vehicle and activate it. Thus, user 106 may only have to select 2 clicks in order to drive a vehicle: (1) select yes to continue with the same vehicle as previously used, and (2) select whether the upcoming vehicle use is for business or personal use. With this, a vehicle in a fleet can be unlocked and ready for use by user 106 in less than a minute, and without the need for any specialized hardware in the vehicle itself.

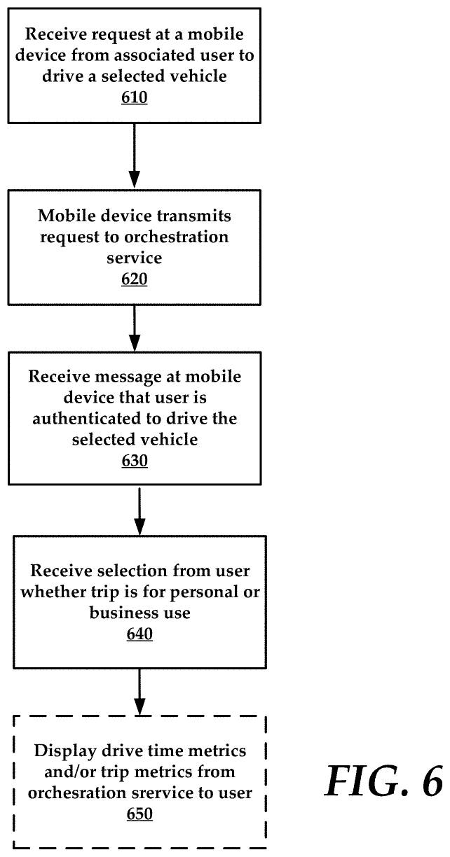

FIG. 6 depicts an exemplary method for a user device to practice exemplary embodiments of the present invention. The method steps are described in concert with the environment of FIG. 3 for clarity. As would be understood by persons of ordinary skill in the art, there may be additional or fewer steps than those depicted in exemplary FIG. 6. In addition, some steps of FIG. 6 may be performed in varying order.

In step 610, a mobile device 108 receives a request from a user 106 (via application 130) to use a particular vehicle 102 of a fleet of vehicles. Typically the vehicle 102 is in a disabled state for security purposes. Mobile device 108 submits that request to orchestration service 104 in step 620. In step 630, user device receives a message from orchestration service 104 that user 106 is authenticated to drive the selected vehicle, or class of vehicles.

In step 640, user device receives a selection from a user whether the vehicle use will be for personal or business use. Once a user has completed a trip with the vehicle, or at another predetermined time, user device may optionally receive and display one or more of vehicle drive time metrics (from vehicle 102 to OEM 134 to orchestration service 104) and/or calculated trip metrics from orchestration service 104, where the calculated trip metrics are based on drive time metrics retrieved from the vehicle itself.

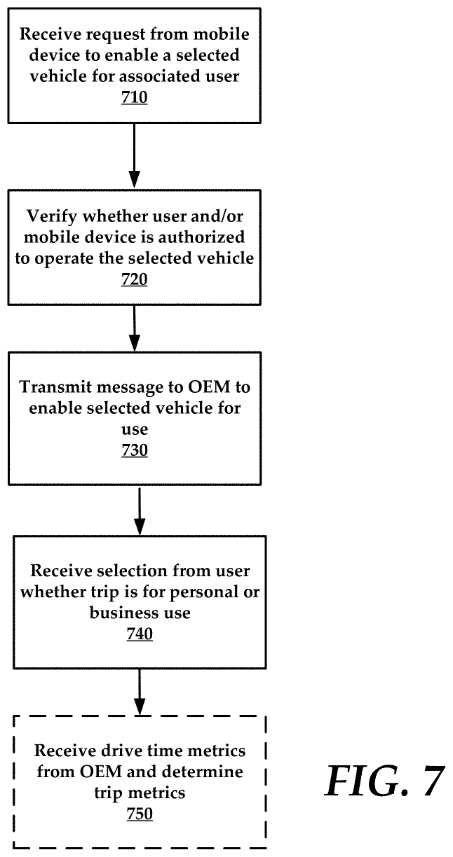

FIG. 7 depicts an exemplary method for an orchestration service to practice embodiments of the present invention. The method steps are described in concert with the environment of FIG. 3 for clarity. As would be understood by persons of ordinary skill in the art, there may be additional or fewer steps than those depicted in exemplary FIG. 7. In addition, some steps of FIG. 7 may be performed in varying order.

In step 710, orchestration service 104 receives a request from a mobile device 108 that an associated user 106 would like to use a particular vehicle 102 of a fleet of vehicles. Typically the vehicle 102 is in a disabled state for security purposes. Orchestration service 104 verifies whether the user 106 and/or associated mobile device 108 is authorized to drive the selected vehicle 102 of the fleet, in step 820. If not authorized, orchestration service 104 may alert an administrator of the fleet that a user is attempting to access a vehicle for which they are unauthorized. The fleet administrator can either contact the user to direct them to the correct vehicle, or can add the user as an authorized user of the requested vehicle in orchestration service 104, if access is warranted.

Though not depicted in the exemplary figure, the method can also include a step where the orchestration service performs a security check prior to allowing the user to have access to the vehicle. That is, the orchestration service can store credentials such as driver's license in the user's account. If the user does not possess the requisite credentials, the user is not allowed to operate or access the vehicle.

If authenticated by orchestration service 104, a message is sent by orchestration service 104 to OEM 134 in step 730 that a user has been approved to drive vehicle 102. In exemplary embodiments, orchestration service 104 communicates with OEM 134 via an API (Application Program Interface) that is managed by the OEM itself. OEM 134 then enables vehicle 102 for driving by sending a message to vehicle controller 112 to unlock a door of the vehicle, enable an ignition start, disable a security system on the vehicle, or any other mechanism. Optionally, any of the two-factor authentication methods disclosed herein may be utilized as part of step 730.

In step 740, orchestration service receives a selection from mobile device 108 that user 106 intends to use the enabled vehicle 102 for personal use or for business use. Once a trip has concluded, or at another predetermined time interval, orchestration service 104 receives drive time metrics from vehicle 102 via the OEM 134.

Optionally, orchestration service 104 determines trip metrics for the vehicle, for the user, or for any other parameter. The determined trip metrics can be displayed to user on mobile device 108, and/or to a system administrator at a predetermined time, or upon request.

The trip metrics are aggregate data that are determined from the raw driving time data (also referred to herein as drive time metrics). Clicking on any of the aggregate data values in a display of mobile device 108 or on HMI 120 may result in the display of more detailed and granular data that was used to calculate the aggregate data. Thus, the user or an authority can drill further into the data if necessary. The data could include other parameters such as on-time, off-time, drive time starts and ends, key-on and key-off events, and so forth.

In one example, the driver may have various key-on and key-off events during a driving period, with each being time stamped by the vehicle controller. That is, the vehicle controller can automatically detect key-on/off events and timestamp these events in a driver log.

Computing System

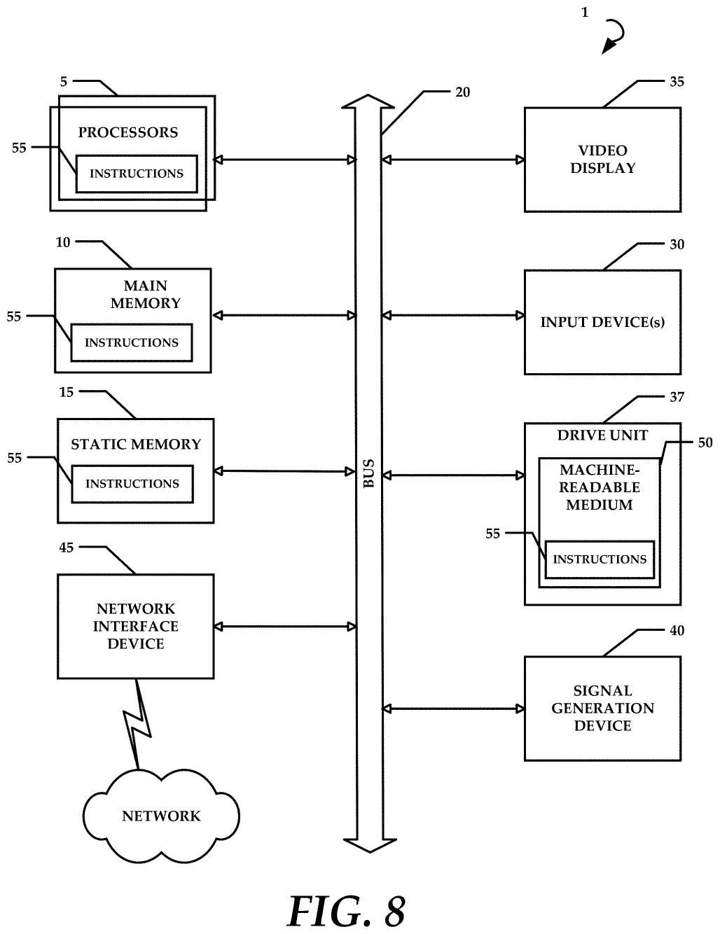

FIG. 8 is a diagrammatic representation of an example machine in the form of a computer system 1, within which a set of instructions for causing the machine to perform any one or more of the methodologies discussed herein may be executed. For example, some or all components of computer system 1 may be utilized to implement any or all of orchestration service 104, OEM 134, application 130, and vehicle controller 112.

In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

Thus, disclosed herein are automatic systems and methods for distinguishing and tracking personal and business use of a vehicle by an orchestration service, without the need for the orchestration service to install any of its own specialized hardware or software on the vehicle itself. By communicating with an OEM that is in direct communications with a vehicle, actual data from the vehicle can be received at the orchestration service, allowing the orchestration service to control access to the vehicle by users and also to retrieve actual driving metrics and data from the vehicle. This data can then be used by the orchestration service to determine trip metrics and automatically track personal and business use by vehicle and also by user.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
receiving a request from a mobile device to enable a selected vehicle for use by a user associated with the mobile device;
verifying that the user is authorized to operate the selected vehicle;
transmitting a message to an Original Equipment Manufacturer (OEM) of the selected vehicle to enable the vehicle for use by the user; and
receiving a selection from the user of a driving type classification for the intended use of the selected vehicle by the user.

2. The method of claim 1, wherein the driving type classification is at least one of: personal use or business use.

3. The method of claim 1, wherein the verifying that the user is authorized to operate the selected vehicle further comprises also verifying that the associated mobile device is authorized.

4. The method of claim 1, wherein the verifying that the user is authorized to operate the selected vehicle comprises utilizing two-factor authentication.

5. The method of claim 1, further comprising:
receiving a plurality of drive time metrics from the OEM of the vehicle at the conclusion of a trip;
utilizing the plurality of drive time metrics to determine at least one trip metric for the driving type classification; and
displaying the at least one trip metric for the driving type classification on a graphical user interface of the mobile device.

6. The method of claim 5, further comprising:
aggregating the at least one trip metric for the driving type classification for all users of the selected vehicle within a predetermined time period.

7. The method of claim 5, further comprising:
aggregating the at least one trip metric for the driving type classification for all vehicles used by the user within a predetermined time period.

8. The method of claim 5, further comprising: determining when the at least one trip metric for the driving type classification exceeds a predetermined time or distance threshold for the user, for the driving type classification.

9. The method of claim 8, wherein further comprising transmitting a warning message to any of the mobile device or a scheduling service, the warning message being indicative of the exceedance of the threshold for the user, for the driving type classification.

10. The method of claim 8, further comprising disabling the vehicle after a key off event upon exceedance of the threshold for the user, for the driving type classification.

11. A system, comprising:
a processor; and
a memory, the processor being configured to execute instructions stored in memory to:
receive a request from a mobile device to enable a selected vehicle for use by a user associated with the mobile device;
verify that the user is authorized to operate the selected vehicle;
transmit a message to an Original Equipment Manufacturer (OEM) of the selected vehicle to enable the vehicle for use by the user; and
receive a selection from the user of a driving type classification for the intended use of the selected vehicle by the user.

12. The system of claim 11, wherein the driving type classification is at least one of: personal use or business use.

13. The system of claim 11, wherein the processor is further configured to verifying that the associated mobile device for the user is authorized.

14. The system of claim 11, wherein the processor is further configured to utilize two-factor authentication to verify that the user is authorized to operate the selected vehicle.

15. The system of claim 11, wherein the processor is further configured to: receive a plurality of drive time metrics from the OEM of the vehicle at the conclusion of a trip;
utilize the plurality of drive time metrics to determine at least one trip metric for the driving type classification; and
display the at least one trip metric for the driving type classification on a graphical user interface of the mobile device.

16. The system of claim 15, wherein the processor is further configured to aggregate the at least one trip metric for the driving type classification for all users of the selected vehicle within a predetermined time period.

17. The system of claim 15, wherein the processor is further configured to aggregate the at least one trip metric for the driving type classification for all vehicles used by the user within a predetermined time period.

18. The system of claim 15, wherein the processor is further configured to determine when the at least one trip metric for the driving type classification exceeds a predetermined time or distance threshold for the user, for the driving type classification.

19. The system of claim 18, wherein the processor is further configured to transmit a warning message to any of the mobile device or a scheduling service, the warning message being indicative of the exceedance of the threshold for the user, for the driving type classification.

20. The system of claim 18, wherein the processor is further configured to disable the vehicle after a key off event upon exceedance of the threshold for the user, for the driving type classification.
